(19) United States
(12) Patent Application Publication
(10) Pub. No.: US 2006/0002353 A1
(43) Pub. Date: Jan. 5, 2006

(54) Relay apparatus and priority control method thereof

(75) Inventor: Takashi Doi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/168,869

(22) Filed: Jun. 29, 2005

(30) Foreign Application Priority Data
Jun. 30, 2004 (JP) 2004-192934

(51) Int. Cl. H04Q 7/24; H04L 12/28

(52) U.S. Cl. 370/338; 370/395.53

(57) ABSTRACT

A relay apparatus for connecting a radio network and a wire network, includes: a priority control unit configured to control a data sending order to the radio network based on a priority assigned to each data piece; a setting unit configured to set the priority in sending data received from the wire network to the radio network; and a priority assigning unit configured to assign the priority set through the setting unit to the data received from the wire network and to be sent to the radio network.

### BACKGROUND OF THE INVENTION

1. Field of the Invention

This invention relates to a radio communication control technique in an access point, etc., for connecting a radio terminal to a wire LAN, for example.

2. Background Art

In recent years, in an office environment, etc., a network environment has been constructed wherein personal computers of employees can be connected to an intraoffice LAN in a wireless manner. A unit for connecting the personal computers to the intraoffice LAN is called access point, etc. This access point forms a part of a radio LAN and has a function of relaying data transfer between the formed radio LAN and the intraoffice LAN of a wire LAN.

Generally, electronic machines for conducting communications under different conditions, such as old and new models of personal computers mix as nodes in both of the radio LAN and the wire LAN connected by the access point. Thus, in recent years, a large number of propositions for absorbing the differences have been made. (For example, see JP-A-2003-110575)

In the technique described in JP-A-2003-110575, the data transmission rate difference is considered for conducting priority management, thereby preventing performance of a radio terminal for receiving data at a high rate from being degraded receiving the effect of a radio terminal for receiving data at a low rate.

### SUMMARY OF THE INVENTION

By the way, in radio LAN communications based on IEEE802.11 springing into wide use at present, a priority control function is developed so that the most of a transmission band can be made in response to the use purpose (IEEE802.11e, WME) According to the priority control function, the transmission band is used with the priority assigned to each application so that video stream application requiring the real-time property (high band/low delay) is not hindered because of network traffic low in the real-time property.

However, to set appropriate priority by the priority control function in the radio LAN communications complying with IEEE802.11e, any desired priority information needs to be previously stored in an IEEE802.1Q VLAN tag of a MAC header. On the other hand, generally, nodes for conducting communications under various conditions mix in the wire LAN as described above, and priority control in the radio LAN cannot be performed for a communication packet transmitted to a node in the radio LAN from a node in the wire LAN where the priority information cannot be set in the MAC header; this is a problem.

It is therefore an object of the invention to provide a relay unit and a relay unit priority control method for making it possible to send even data received from a node in a wire network where the priority cannot be set to a radio network under the appropriate priority control.

To achieve the object, the invention provides a relay apparatus for connecting a radio network and a wire network, including: a priority control unit configured to control a data sending order to the radio network based on a priority assigned to each data piece; a setting unit configured to set the priority in sending data received from the wire network to the radio network; and a priority assigning unit configured to assign the priority set through the setting unit to the data received from the wire network and to be sent to the radio network.

The invention provides a priority control method of a relay apparatus for connecting a radio network and a wire network. The priority control method includes: setting a priority in sending data received from the wire network to the radio network; assigning the setup priority to the data received from the wire network and to be sent to the radio network; and controlling a data sending order to the radio network based on the assigned priority.

The invention may provide a relay apparatus for connecting a radio network and a wire network, including: an extracting unit configured to extract priority information corresponding to an IP header of a packet that is received from the wire network to be sent to the radio network; a priority generating unit configured to generate a priority to be assigned to the packet based on the priority information; and a storing unit configured to store the generated priority to a section corresponding to a physical layer of the packet.

The invention may provide a priority control method of a relay apparatus for connecting a radio network and a wire network. The priority control method includes: extracting priority information corresponding to an IP header of a packet that is received from the wire network to be sent to the radio network; generating a priority to be assigned to the packet based on the priority information; and storing the generated priority to a section corresponding to a physical layer of the packet.

According to the invention, there can be provided the relay unit and the relay unit priority control method for making it possible to send even data received from a node in a wire network where the priority cannot be set to a radio network under the appropriate priority control.

### BRIEF DESCRIPTION OF THE DRAWINGS

The present invention may be more readily described with reference to the accompanying drawings:

FIG. 1 is a drawing to show an application example of a relay unit according to one embodiment of the invention;

FIG. 2 is a block diagram to show the hardware configuration of an access point of the embodiment of the invention;

FIG. 3 is a block diagram to show the software configuration of the access point of the embodiment of the invention;

FIG. 4 is a drawing to show an example of a priority setting GUI provided for the user by the access point of the embodiment of the invention; and

FIG. 5 is a flowchart to show the operation principle of priority control executed in a bridge of the access point of the embodiment of the invention.

### DETAILED DESCRIPTION OF THE PREFERRED EMBODIMENTS

Referring now to the accompanying drawings, there is shown a preferred embodiment of the invention.

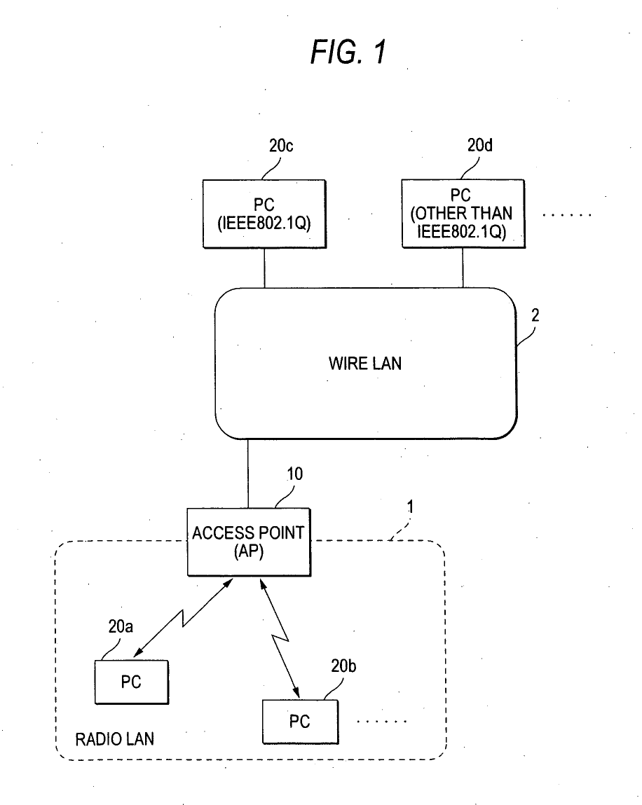

FIG. 1 is a drawing to show an application example of a relay unit according to one embodiment of the invention. Here, an example wherein a relay unit of the invention is implemented as an access point (AP) 10 will be discussed. The access point 10 controls radio communications with a plurality of radio communication units containing personal computers (PCs) 20a and 20b, thereby constructing a radio LAN (local area network) 1. The PCs 20a and 20b belonging to the radio LAN 1 can transmit and receive data to and from each other via the access point 10. The access point 10 has a relay function of connecting the constructed radio LAN 1 and a wire LAN 2, whereby the PCs 20a and 20b can also transmit and receive data to and from a PC 20c, a PC 20d, etc., connected to the wire LAN 2 by a cable.

The access point 10 conducts radio LAN communications complying with IEEE802.11e. To send data received from the wire LAN 2 to the radio LAN 1, the access point 10 executes priority control based on the priority information stored in an IEEE802.1Q VLAN tag of a MAC (media access control) header. This means that the access point 10 basically assumes that the wire communication units containing the PC 20c and the PC 20d connected to the wire LAN 2 by a cable conduct wire LAN communications complying with IEEE802.1Q. In fact, however, generally a wire communication unit for conducting wire LAN communications under any other condition also mixes with the wire communication units. Then, here it is assumed that the PC 20C conducts wire LAN communications complying with IEEE802.1Q and the PC 20d conducts wire LAN communications complying with any other communication protocol than IEEE802.1Q. This means that the MAC header of data sent from the PC 20d to the PC 20a, the PC 20b, etc., under the command of the radio LAN 1 does not contain the IEEE802.1Q VLAN tag required for priority control. The access point 10 makes it possible to send even such data to the radio LAN 1 under the appropriate priority control. This point will be discussed below in detail:

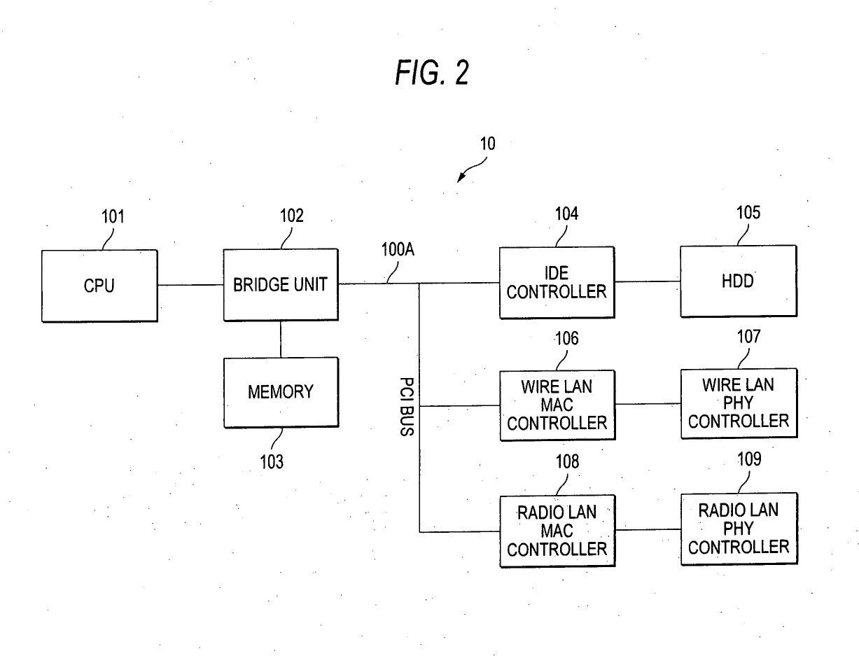

FIG. 2 is a block diagram to show the hardware configuration of the access point 10. As shown in the figure, the access point 10 has a CPU 101, a bridge unit 102, memory 103, an IDE controller 104, a hard disk drive (HDD) 105, a wire LAN MAC controller 106, a wire LAN PHY controller 107, a radio LAN MAC controller 108, and a radio LAN PHY controller 109.

The CPU 101 controls the whole system of the access point 10 in accordance with a program loaded into the memory 103. The bridge unit 102 controls data transfer between the CPU 101 and the memory 103, and communications between the CPU 101 and the IDE controller 104, the wire LAN MAC controller 106, and the radio LAN MAC controller 108.

The memory 103 stores the program executed by the CPU 101 and is used as a temporary storage location of data required for system control. The IDE controller 104 performs drive control of the HDD 105. The HDD 105 stores programs for operating the system and video data as auxiliary storage of the memory 103.

The wire LAN MAC controller 106 executes communication control in the wire LAN 2 in conjunction with the wire LAN PHY controller 107. On the other hand, the radio LAN MAC controller 108 executes communication control in the radio LAN 1 in conjunction with the radio LAN PHY controller 109. A PCI bus 100A connects PCI devices and the bridge unit 102 forming the system.

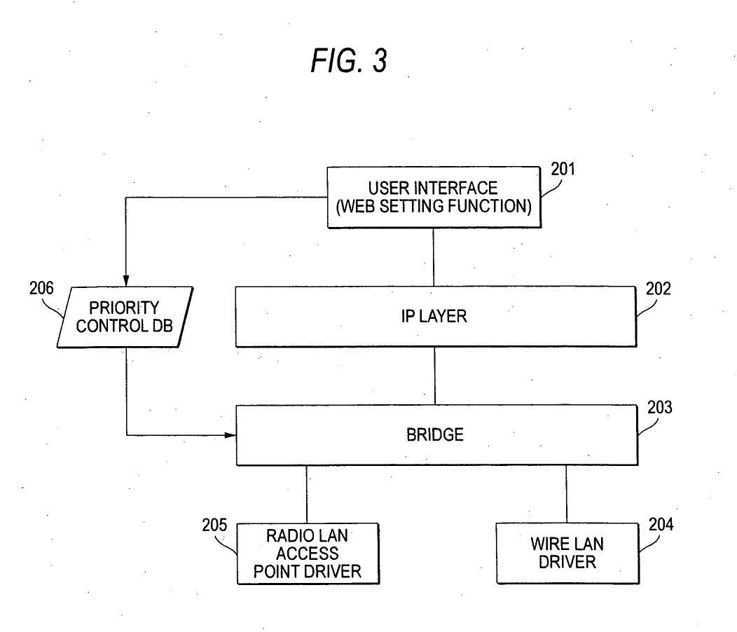

FIG. 3 is a block diagram to show the software configuration of the access point 10. As shown in the figure, the access point 10 has a user interface 201, an IP (Internet protocol) layer 202, a bridge 203, a wire LAN driver 204, a radio LAN access point driver 205, and a priority control database (DB) 206.

The user interface 201 provides a setting function in the home page format to allow the user to set the system (Web setting function). The IP layer 202 provides an IP communication function for the user interface 201. The bridge 203 controls transfer of a packet at the MAC level between the IP layer 202 and the wire LAN driver 204 and the radio LAN access point driver 205. The bridge 203 executes processing to send even data with the above-described IEEE802.1Q VLAN tag not contained in the MAC header, such as data sent from the PC 20d, for example, to the PC 20a, the PC 20b, etc., under the command of the radio LAN 1, to the radio LAN 1 under the appropriate priority control. The operation principle is described later in detail.

The wire LAN driver 204 is connected to the bridge 203 for controlling a communication packet in the radio LAN 2. On the other hand, the radio LAN access point driver 205 provides an access point function of the radio LAN 1 and also executes control at the link level of the radio LAN 1 using a priority control function of IEEE802.11e, WME.

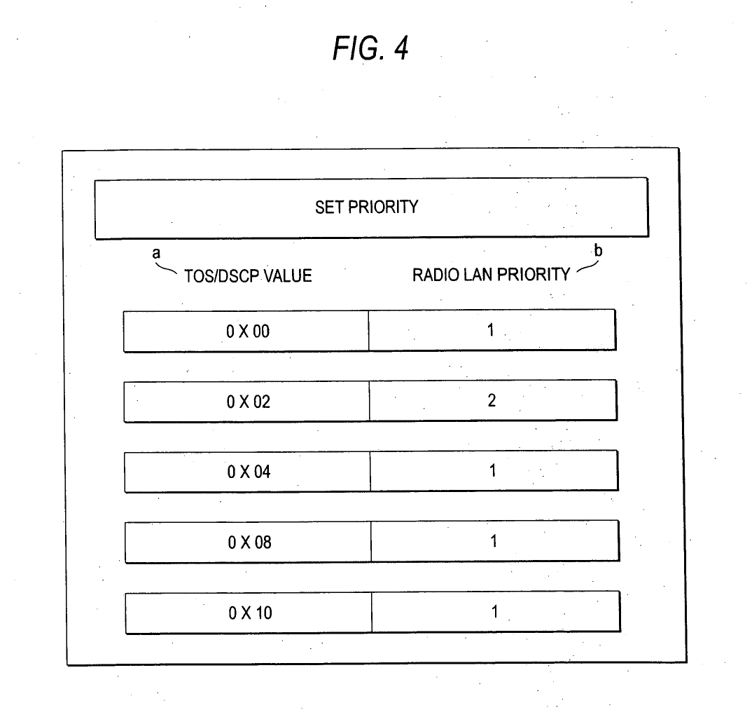

The priority control DB 206 retains the priority information set by the user using the user interface 201. The priority information retained in the priority control DB 206 is referenced if it becomes necessary to add an IEEE802.1Q VLAN tag in the bridge 203. FIG. 4 shows an example of a priority setting GUI (Graphical User Interface) provided by the user interface 201 for the user.

As shown in the figure, on the priority setting GUI provided by the user interface 20l, TOS/DSCP values which may be contained in TCP, UDP/IP header are listed in a field a. The priority setting GUI enables the user to enter the radio LAN communication priority for the communication packet containing the TOS/DSCP value in a field b as desired. The settings made on the priority setting GUI are retained in the priority control DB 206 as the priority information. In the example in FIG. 4, to receive a communication packet with TOS/DSCP value “0x00” and a communication packet with TOS/DSCP value “0x02” from the wire LAN 2 and send the communication packets to the radio LAN 1, the communication packet with the TOS/DSCP value “0x00” takes precedence over the communication packet with the TOS/DSCP value “0x02.”

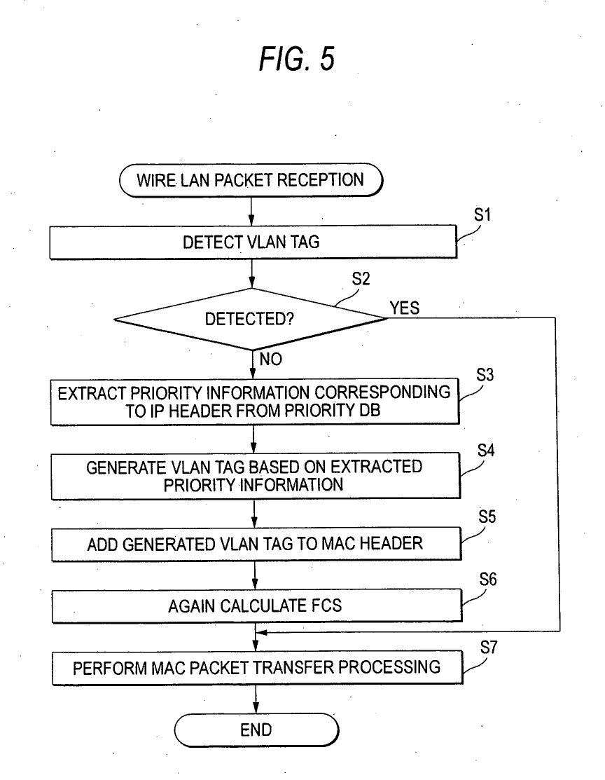

Next, the operation principle of the priority control executed in the bridge 203 of the access point 10 will be discussed with reference to FIG. 5.

Upon reception of a communication packet from the wire LAN driver 204, the bridge 203 checks whether or not the MAC header contains a VLAN tag (step S1). If a VLAN tag is contained (YES at step S2), the bridge 203 uses the priority information stored in the VLAN tag as it is, and executes MAC packet transfer processing (step S7).

On the other hand, if the MAC header does not contain a VLAN tag (NO at step S2), the bridge 203 references the priority control DB 206 based on the information in a TCP, UDP/IP header of the packet, and extracts the corresponding priority information (step S3). The bridge 203 generates an IEEE802.1Q VLAN tag based on the extracted priority information (step S4) and adds the generated VLAN tag to the MAC header of the reception packet (step S5).

At this time, the bridge 203 again calculates FCS (frame check sequence) of the packet to which the VLAN tag is added for update (step S6). The bridge 203 executes MAC packet transfer processing of the packet to which the VLAN tag is added (step S7).

As described above, although the priority information (IEEE802.11e, WME) of radio LAN communications cannot be set unless a VLAN tag exists, the access point 10 of the embodiment makes it possible to set the priority information (IEEE802.11e, WME) even in communications with no IEEE802.1Q VLAN tag and also makes it possible to customize the priority in transfer to the radio LAN as desired.

In description of the embodiment, the priority in the radio LAN is set for each TOS/DSCP value contained in the TCP, UDP/IP header by way of example, but the technique of the invention is not limited to it and the priority may be set according to any rule.

That is, it is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A relay apparatus for connecting a radio network and a wire network, comprising:
a priority control unit configured to control a data sending order to the radio network based on a priority assigned to each data piece;
a setting unit configured to set the priority in sending data received from the wire network to the radio network; and
a priority assigning unit configured to assign the priority set through the setting unit to the data received from the wire network and to be sent to the radio network.

2. The relay apparatus as claimed in claim 1,
wherein, when the data received from the wire network contains data having a predetermined attribute, the priority assigning unit assigns the priority based on the data; and
when the data received from the wire network does not contain data having the predetermined attribute, the priority assigning unit assigns the priority set through the setting unit.

3. The relay apparatus as claimed in claim 2,
wherein the data having the predetermined attribute is data stored in an IEEE802.1Q VLAN tag of a MAC (media access control) header.

4. The relay apparatus as claimed in claim 3, wherein the priority assigning unit includes an update unit configured to generate an IEEE802.1Q VLAN tag storing data corresponding to the priority set through the setting unit when the MAC header of the data received from the wire network does not contain an IEEE802.1Q VLAN tag, to add the generated IEEE802.1Q VLAN tag to the MAC header, and to re-calculate FCS (frame check sequence) of a packet with the MAC header to which the IEEE802.1Q VLAN tag is added for update.

5. The relay apparatus as claimed in claim 1,
wherein the setting unit sets the priority for each TOS/DSCP value contained in the TCP, UDP/IP header of the data received from the wire network.

6. A priority control method of a relay apparatus for connecting a radio network and a wire network, the priority control method comprising:
setting a priority in sending data received from the wire network to the radio network;
assigning the setup priority to the data received from the wire network and to be sent to the radio network; and
controlling a data sending order to the radio network based on the assigned priority.

7. A relay apparatus for connecting a radio network and a wire network, comprising:
an extracting unit configured to extract priority information corresponding to an IP header of a packet that is received from the wire network to be sent to the radio network;
a priority generating unit configured to generate a priority to be assigned to the packet based on the priority information; and
a storing unit configured to store the generated priority to a section corresponding to a physical layer of the packet.

8. The relay apparatus as claimed in claim 7, wherein
the section corresponding to the physical layer of the packet is an IEEE802.1Q VLAN tag of a MAC header.

9. The relay apparatus as claimed in claim 8, further comprising: an update unit configured to re-calculate FCS (frame check sequence) of the packet with the MAC header to which the IEEE802.1Q VLAN tag is added for update.

10. The relay apparatus as claimed in claim 7, wherein the priority information is set for each TOS/DSCP value contained in the IP header.

11. A priority control method of a relay apparatus for connecting a radio network and a wire network, the priority control method comprising:
extracting priority information corresponding to an IP header of a packet that is received from the wire network to be sent to the radio network;
generating a priority to be assigned to the packet based on the priority information; and
storing the generated priority to a section corresponding to a physical layer of the packet.
